(19) United States
(12) Patent Application Publication
(10) Pub. No.: US 2012/0104960 A1
(43) Pub. Date: May 3, 2012

(54) CIRCUIT FOR CONVERTING DC INTO AC PULSED VOLTAGE

(75) Inventors: Chenyang Liu, Shanghai (CN); Ang Ding, Shanghai (CN); Bin Wu, Shanghai (CN)

(73) Assignee: KONINKLIJKE PHILIPS ELECTRONICS N.V., EINDHOVEN (NL)

(21) Appl. No.: 13/381,261

(22) PCT Filed: Jun. 24, 2010
(86) PCT No.: PCT/IB10/52886

§ 371 Date: Dec. 28, 2011

(30) Foreign Application Priority Data
Jun. 30, 2009 (CN) 200910139596.2

(51) Int. Cl. H05B 41/282; H02M 7/537

(52) U.S. Cl. 315/210; 363/95

(57) ABSTRACT

The present invention proposes a circuit for converting DC into AC pulsed voltage. The circuit comprises two or four controllable semiconductor switches as well as a corresponding controller unit. The controller unit controls the opening and closing of the two or four controllable semiconductor switches using a preset control mode. When the circuit is used as the driver circuit of a capacitive load such as a DBD lamp, the luminous efficiency of the DBD lamp is improved.

### TECHNICAL FIELD

The present invention relates to circuits for converting DC into AC pulsed voltage, particularly to driver circuits for driving dielectric barrier discharge lamps.

### BACKGROUND OF THE INVENTION

Dielectric barrier discharge (DBD, in short) is also known as “silent discharge”. Dielectric barrier discharge lamps with xenon filling attract wide interest because of the advantages of stable operation independent of temperature and conditions, immediate light production, long lifetime, high-energy UV radiation, absence of mercury and so on.

DBD lamps can be operated with continuous excitation or with pulsed excitation. It has been shown that pulsed operation in conjunction with a modified gas pressure leads to a significantly higher luminous efficiency of the lamp. For high-efficiency DBD lamps, pulsed operation is preferred, while continuous excitation is used in applications where efficiency requirements are not high.

Before ignition DBD lamps are near-to-perfect capacitive loads. This is due to the fact that the two electrodes are encapsulated with dielectric materials while being geometrically close to each other. After ignition there is an additional capacitance and a dissipative component, both induced by the gas discharge. Thus the standard electrical model for any DBD lamp consists of two capacitors and a resistor. Usually, ignition of a DBD lamp may require voltages of approximately 5 kVpp and in normal operating mode the driving voltage may be approximately 3 kVpp, while the lamp power factor is lower than 0.3. Furthermore, the operating frequency and dV/dt of the driving voltage have an impact on the lamp efficiency and the discharge stability.

So, how to design a circuit with suitable pulse voltage adapted for high luminous efficiency of DBD lamps is a problem that needs to be solved.

### SUMMARY OF THE INVENTION

The present invention proposes an embodiment of a circuit for converting DC into AC pulsed voltage in one embodiment. The circuit comprises two or four controllable semiconductor switches as well as a corresponding controller unit. The controller unit controls the opening and closing of the two or four controllable semiconductor switches using a preset control mode, respectively.

According to an embodiment of the present invention, there is proposed a circuit for converting DC into AC pulsed voltage, the circuit comprising a converter circuit and a controller unit. Said converter circuit is configured to drive a load and comprises a first controllable semiconductor switch, a second controllable semiconductor switch, a capacitor and a transformer, wherein the series circuit of said first controllable semiconductor switch and said capacitor is connected in series with the primary side of said transformer and said second controllable semiconductor switch is connected in parallel with the series circuit of said capacitor and the primary side of said transformer. Said controller unit is configured to control the opening and closing of said first controllable semiconductor switch and said second controllable semiconductor switch using a first preset control mode so that the switches are opened and closed periodically or nonperiodically in the following mode: during a time period T, said first controllable semiconductor switch is closed for a period of time t1 and then opened for a period of time t2, and said second controllable semiconductor switch is opened for a period of time t1, then closed for a period of time t3, then opened for a period of time t4, and then closed for a period of time t5, wherein t1+t2=T and t1+t3+t4+t5=T.

According to another embodiment of the present invention, there is proposed a circuit for converting DC into AC pulsed voltage, the circuit comprising a converter circuit and a controller unit. Said converter circuit is configured to drive a load and comprises a third controllable semiconductor switch, a fourth controllable semiconductor switch, a fifth controllable semiconductor switch, a sixth controllable semiconductor switch, a capacitor and a transformer, wherein the series circuit of said third and sixth controllable semiconductor switches is connected in parallel with the series circuit of said fourth and fifth controllable semiconductor switches, one terminal of the series circuit of said capacitor and the primary side of said transformer is connected to the midpoint of the third and sixth controllable semiconductor switches and the other terminal is connected to the midpoint of the fourth and fifth controllable semiconductor switches. Said controller unit is configured to control the opening and closing of said third, fourth, fifth, and sixth controllable semiconductor switches using a third preset control mode so that the switches are opened and closed periodically or nonperiodically in the following mode: during a time period T, said third and fifth controllable semiconductor switches are closed for a period of time t1 and then opened for a period of time t2, and said fourth and sixth controllable semiconductor switches are opened for a period of time t1, then closed for a period of time t3, then opened for a period of time t4, and then closed for a period of time t5, wherein t1+t2=T and t1+t3+t4+t5=T.

According to another embodiment of the present invention, there is proposed a driving circuit for driving DBD lamps, which circuit comprises the above mentioned circuit for converting DC into AC pulsed voltage.

According to another embodiment of the present invention, there is proposed a method of controlling a circuit for converting DC into AC pulsed voltage, the circuit comprising a converter circuit and a controller unit. Said converter circuit is configured to drive a load and comprises a first controllable semiconductor switch, a second controllable semiconductor switch, a capacitor and a transformer, wherein the series circuit of said first controllable semiconductor switch and said capacitor is connected in series with the primary side of said transformer and said second controllable semiconductor switch is connected in parallel with the series circuit of said capacitor and the primary side of said transformer. Said method comprises the following step: controlling the opening and closing of said first controllable semiconductor switch and said second controllable semiconductor switch using a first preset control mode so that the switches are opened and closed periodically or nonperiodically in the following mode: during a time period T, said first controllable semiconductor switch is closed for a period of time t1 and then opened for a period of time t2, and said second controllable semiconductor switch is opened for a period of time t1, then closed for a period of time t3, then opened for a period of time t4, and then closed for a period of time t5, wherein t1+t2=T and t1+t3+t4+t5=T.

According to another embodiment of the present invention, there is proposed a method of controlling a circuit for converting DC into AC pulsed voltage, the circuit comprising a converter circuit and a controller unit. Said converter circuit is configured to drive a load and comprises a third controllable semiconductor switch, a fourth controllable semiconductor switch, a fifth controllable semiconductor switch, a sixth controllable semiconductor switch, a capacitor and a transformer, wherein the series circuit of said third and sixth controllable semiconductor switches is connected in parallel with the series circuit of said fourth and fifth controllable semiconductor switches, one terminal of the series circuit of said capacitor and the primary side of said transformer is connected to the midpoint of the third and sixth controllable semiconductor switches and the other terminal is connected to the midpoint of the fourth and fifth controllable semiconductor switches. Said method comprises the following step: controlling the opening and closing of said third, fourth, fifth, and sixth controllable semiconductor switches using a third preset control mode so that the switches are opened and closed periodically or nonperiodically in the following mode: during a time period T, said third and fifth controllable semiconductor switches are closed for a period of time t1 and then opened for a period of time t2, and said fourth and sixth controllable semiconductor switches are opened for a period of time t1, then closed for a period of time t3, then opened for a period of time t4, and then closed for a period of time t5, wherein t1+t2=T and t1+t3+t4+t5=T.

When the circuits of present invention are used as the driver circuits of capacitive loads such as DBD lamps, the luminous efficiency of DBD lamps is improved.

### BRIEF DESCRIPTION OF THE DRAWINGS

The above and other objects, characteristics and merits of the present invention will become more apparent from the following detailed description considered in connection with the accompanying drawings, in which:

FIG. 1 is a schematic diagram of a circuit for converting DC into AC pulsed voltage;

FIG. 2(a) is a schematic diagram showing a first preset control mode for the first controllable semiconductor switch 1011 and the second controllable semiconductor switch 1012 in FIG. 1 according to an embodiment of the present invention;

FIGS. 2(b) and 2(c) are schematic diagrams corresponding to the DBD lamp operating in the ignition mode and in the normal operating mode, respectively, representing waveforms of voltage and current of the DBD lamp when the first and second controllable semiconductor switches are controlled by the first preset control mode shown in FIG. 2(a);

FIG. 3 is a schematic diagram of a circuit for converting DC into AC pulsed voltage according to an embodiment of the present invention;

FIG. 4 is a schematic diagram showing a second preset control mode of the first controllable semiconductor switch 1011 and the second controllable semiconductor switch 1012 in FIG. 1, and the corresponding voltage and current waveforms of the DBD lamp when the DBD lamp operates in the ignition mode;

FIG. 5 is a schematic diagram of a circuit for converting DC into AC pulsed voltage according to another embodiment of the present invention;

FIG. 6 is a schematic diagram of a third preset control mode of the third controllable semiconductor switch 5011, the fourth controllable semiconductor switch 5012, the fifth controllable semiconductor switch 5013 and the sixth controllable semiconductor switch 5014 in the circuit in FIG. 5;

FIG. 7 is a schematic diagram of a circuit for converting DC into AC pulsed voltage according to another embodiment of the present invention;

FIG. 8 is a schematic diagram of a third preset control mode of the third controllable semiconductor switch 5011, the fourth controllable semiconductor switch 5012, the fifth controllable semiconductor switch 5013 and the sixth controllable semiconductor switch 5014 in the circuit in FIG. 7;

FIG. 9 is a flow chart of a method of controlling a circuit for converting DC into AC pulsed voltage according to an embodiment of the present invention;

FIG. 10 is a flow chart of a method of controlling a circuit for converting DC into AC pulsed voltage according to an embodiment of the present invention,

wherein the similar reference numerals are used to denote similar step characteristics/means (modules) throughout the figures.

### DETAILED DESCRIPTION OF THE EMBODIMENTS

Hereinafter, embodiments of the present invention are described in detail with reference to the accompanying drawings.

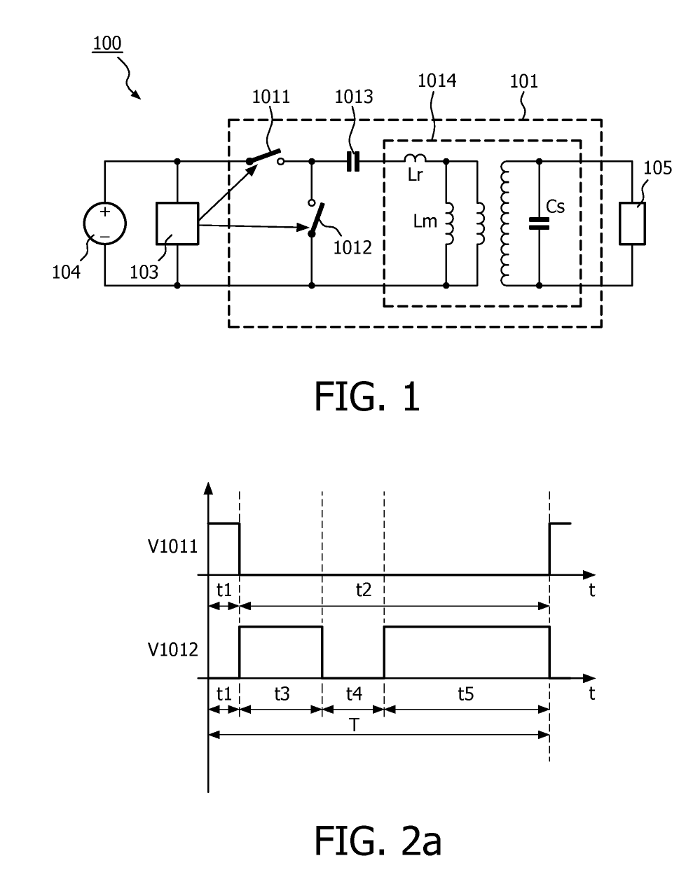

FIG. 1 is a schematic diagram of a driving circuit for driving a load 105, e.g. a DBD lamp, according to an embodiment of the present invention. The driving circuit comprises a converter circuit 101, a controller unit 103, a power supply 104 and a load 105. The converter circuit 101 and a controller unit 103 forms the circuit 100 for converting DC into AC pulsed voltage, of course, the circuit 100 may comprise other functional unit. The power supply 104 is a DC source, which can be converted from an AC source, for instance, the mains supply.

The converter circuit 101 comprises a first controllable semiconductor switch 1011, a second controllable semiconductor switch 1012, a capacitor 1013 and a transformer 1014, wherein the series circuit of the first controllable semiconductor switch 1011 and the capacitor 1013 is connected in series with the primary side of the transformer 1014 and the second controllable semiconductor switch 1012 is connected in parallel with the series circuit of the capacitor 1013 and the primary side of the transformer 1014. It should be noted that FIG. 1 illustrates an equivalent circuit of the transformer 1014, comprising a leakage inductance Lr, a magnetizing inductance Lm, a parasitic capacitor Cs and a primary-to-secondary turns ratio of 1:n, wherein the value of n can be modified according to the requirements of a practical circuit. The first and second controllable semiconductor switches 1011 and 1012 can be composed of semiconductor devices such as bipolar transistors, field effect transistors, and so on.

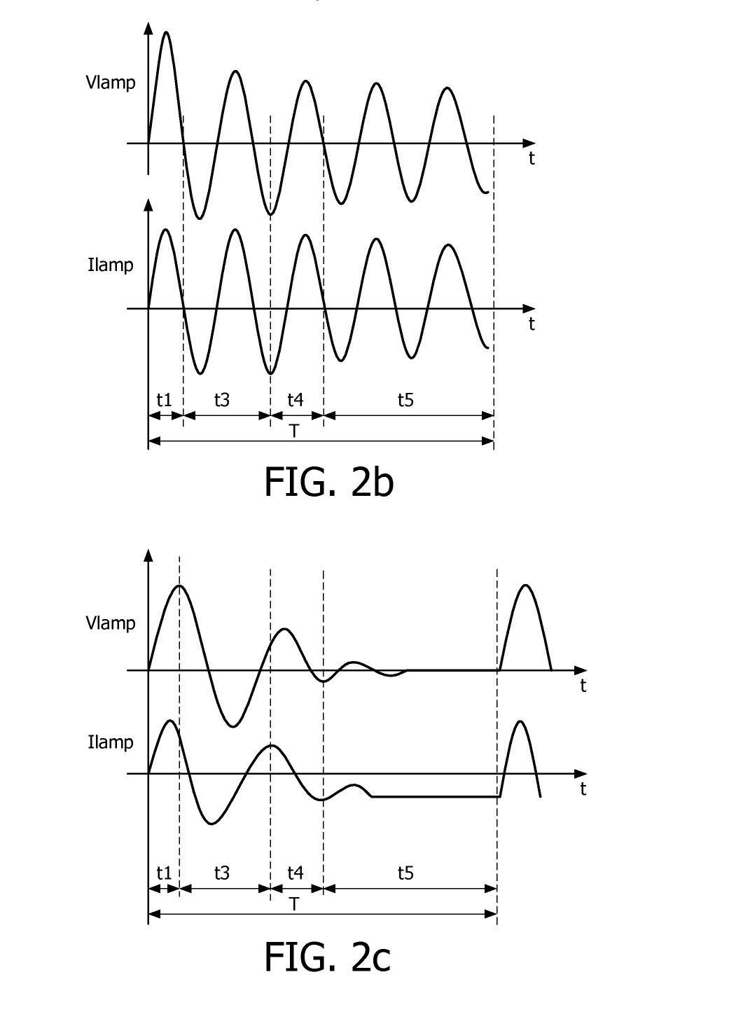

FIG. 2(a) illustrates a schematic diagram showing a first preset control mode for the first controllable semiconductor switch 1011 and the second controllable semiconductor switch 1012 in FIG. 1 according to an embodiment of the present invention. Without loss of generality, hereinafter, the operation process of the circuit in FIG. 1, controlled by the first preset control mode in FIG. 2(a), is described in detail, taking it for example that the load 105 is a DBD lamp. It should be noted that FIG. 2(a) is a schematic diagram for a single time period T and the value of T can be constant or change over time.

During a time period T, the controller unit 103 controls the first controllable semiconductor switch 1011 so that the switch is closed for a period of time t1, then opened for a period of time t2, and the controller unit 103 controls the second controllable semiconductor switch 1012 so that the switch is opened for a period of time t1, then closed for a period of time t3, then opened for a period of time t4, and then closed for a period of time t5, wherein t1+t2=T and t1+t3+t4+t5=T. In an embodiment, t1 is much shorter than t2. In other words, the controller unit 103 generates driving signals V₁₀₁₁ and V₁₀₁₂ for driving the first and second controllable semiconductor switches 1011 and 1012, and applies these signals to the first and second controllable semiconductor switches 1011 and 1012 respectively. In FIG. 2(a) and the following FIG. 4, FIG. 6 and FIG. 8, the high level voltage denotes a voltage enabling closing of a controllable semiconductor switch and the low level voltage denotes a voltage enabling opening of a controllable semiconductor.

It should be noted that the value of t1 determines the input energy during a time period T. The value of T can be modified according to the power requirements of the DBD lamp or the electrical parameters of the converter circuit. In an embodiment, the value of T can be from 5 μs to 50 μs and the value of t1 can be from 100 ns to 1 μs. The value of T and t1 can be constant or change over time.

Usually, the operating modes of a DBD lamp can be classified into two kinds, the ignition mode and the normal operating mode. According to the characteristics of a DBD lamp, before ignition, i.e., in the ignition mode, the DBD lamp is a near-to-perfect capacitive load. This is due to the fact that the electrodes are encapsulated with dielectric materials while being geometrically close to each other. After ignition there is an additional capacitance and a dissipative component, both induced by the gas discharge. Thus the standard electrical model for the DBD lamp comprises two capacitors and a resistor. Usually, ignition of a DBD lamp may require voltages of approximately 5 kVpp and in normal operating mode the driving voltage may be approximately 3 kVpp.

FIGS. 2(b) and 2(c) are schematic diagrams corresponding to a DBD lamp operating in the ignition mode and in the normal operating mode, respectively, representing waveforms of voltage and current of the DBD lamp when the first and second controllable semiconductor switches are controlled by the first preset control mode shown in FIG. 2(a). As shown in FIG. 2(c), when the DBD lamp operates in the normal operating mode, the amplitudes of the voltage and current are well suppressed and the electric energy is saved effectively. In FIG. 2(b), however, there is still much electric energy loss due to the slow voltage and current damping.

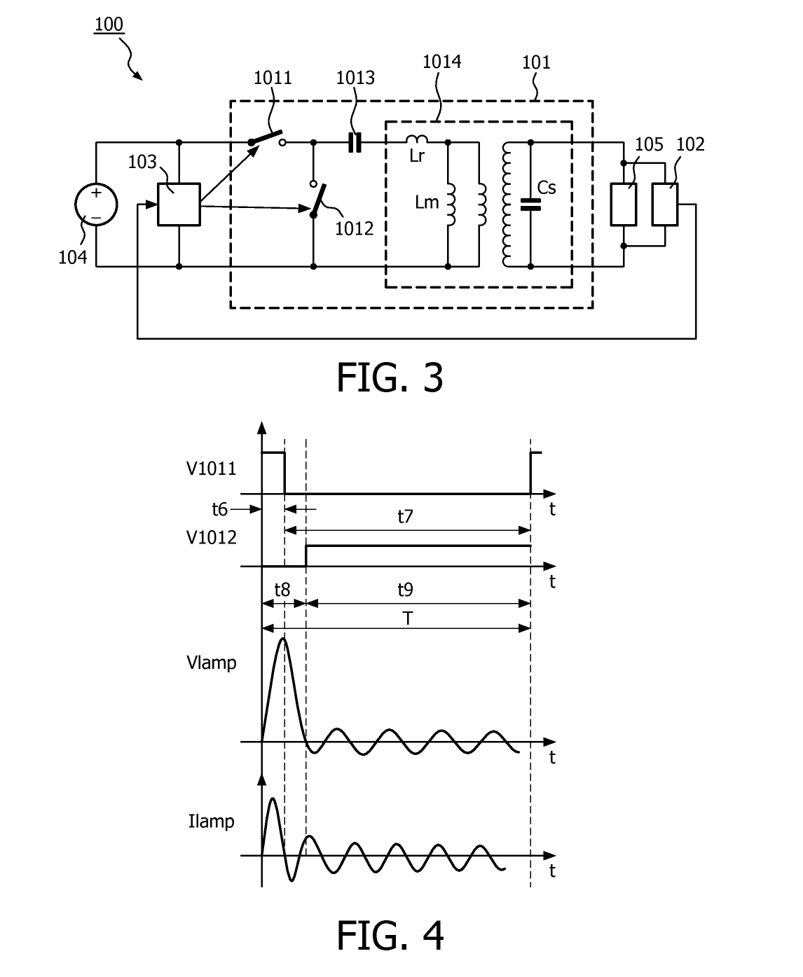

Optionally, the circuit 100 in FIG. 1 can further comprise a detector unit 102, as shown in FIG. 3. With respect to DBD lamps operating in the ignition mode, the first preset control mode shown in FIG. 4 can be adopted.

First, the detector unit 102 detects whether the DBD lamp operates in the ignition mode or in the normal operating mode. Specifically, the detector unit 102 can detect the voltage at the two terminals of the DBD lamp or the current through the DBD lamp. As described above, the voltage at the terminals of the DBD lamp in the ignition mode is much higher than in the normal operating mode. In the ignition mode, the average current through the DBD lamp is zero while in the normal operating mode, the average current through the DBD lamp is much higher than zero.

If the DBD lamp operates in the normal operating mode, then the controller unit 103 controls the opening and closing of the first controllable semiconductor switch 1011 and the second controllable semiconductor switch 1012 using the first preset mode in FIG. 2(a).

If the DBD lamp operates in the ignition mode, then the controller unit 103 controls the first controllable semiconductor switch 1011 and the second controllable semiconductor switch 1012 using the second preset control mode in FIG. 4 so that the switches are closed and opened periodically or nonperiodically, i.e., the value of T in FIG. 4 can be constant or change over time. As shown in FIG. 4, during a time period T, the controller unit 103 controls the first controllable semiconductor switch 1011 so that the switch is closed for a period of time t6 and then opened for a period of time t7, and the controller unit 103 controls the second controllable semiconductor switch 1012 so that the switch is opened for a period of time t8 and then closed for a period of time t9, wherein t6+t7=T, t8+t9=T and t6<t8.

The lower half part of FIG. 4 illustrates a schematic diagram of waveforms of both the voltage Vlamp at the terminals of the DBD lamp and the current Ilamp through the lamp when the DBD lamp operates in the ignition mode. As shown in FIG. 4, when the second preset control mode in FIG. 4 is adopted and the DBD lamp operates in the ignition mode, the amplitudes of the voltage and current are well suppressed and the electric energy is effectively saved.

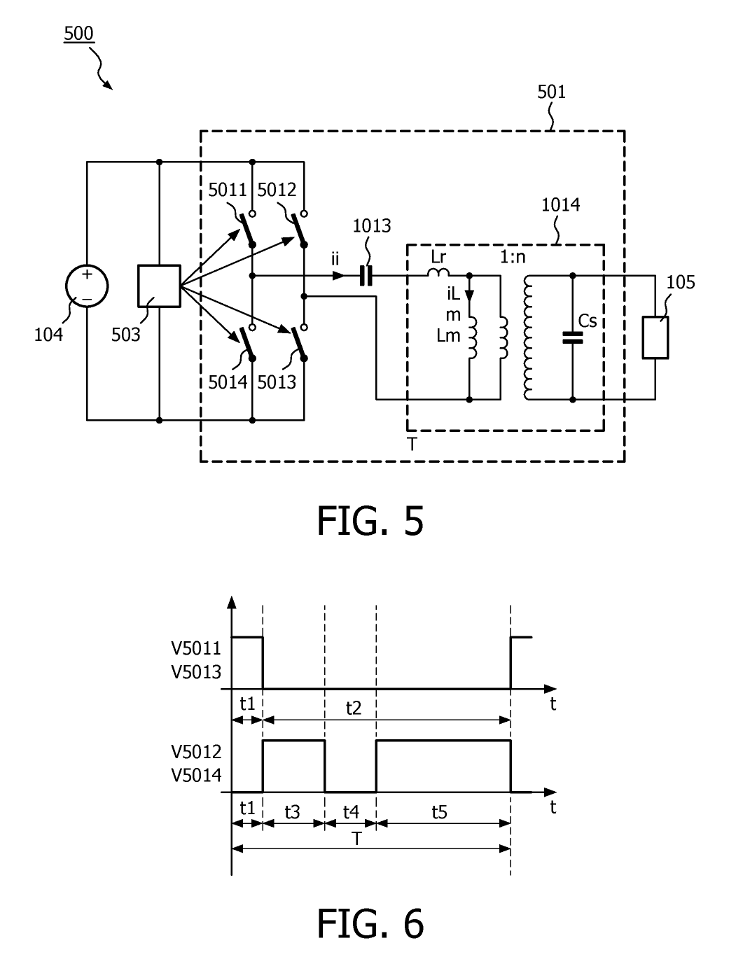

The circuit 100 for converting DC into AC pulsed voltage in FIG. 1 or FIG. 3 is based on a half bridge circuit which can be replaced by a full bridge circuit. FIG. 5 illustrates a schematic diagram of a circuit 500 for converting DC into AC pulsed voltage based on a full bridge circuit according to another embodiment of the present invention.

In FIG. 5, the circuit 500 comprises a converter circuit 501, a controller unit 503, a power supply 104 and a load 105. The converter circuit 501 comprises a third controllable semiconductor switch 5011, a fourth controllable semiconductor switch 5012, a fifth controllable semiconductor switch 5013, a sixth controllable semiconductor switch 5014, a capacitor 1013 and a transformer 1014, wherein the series circuit of the third controllable semiconductor switch 5011 and the sixth controllable semiconductor switch 5014 is connected in parallel with the series circuit of the fourth controllable semiconductor switch 5012 and the fifth controllable semiconductor switch 5013, and one terminal of the series circuit of said capacitor 1013 and the primary side of said transformer 1014 is connected to the midpoint of the third controllable semiconductor switch 5011 and the sixth controllable semiconductor switch 5014 and the other terminal is connected to the midpoint of the fourth controllable semiconductor switch 5012 and the fifth controllable semiconductor switch 5013.

It should be noted that the only difference between the converter circuit 501 in FIG. 5 and the converter circuit 101 in FIG. 1 is the type of bridge circuit. So, the controller unit 503 can control the semiconductor switches using a control mode similar to the first preset control mode in FIG. 2(a).

FIG. 6 illustrates a schematic diagram of a third preset control mode configured to control the controllable semiconductor switches in FIG. 5 according to an embodiment of the present invention.

Without loss of generality, hereinafter the operation process of the circuit in FIG. 5, controlled by the third preset control mode in FIG. 6, is described in detail, taking it for example that the load 105 is a DBD lamp. It should be noted that FIG. 6 is a schematic diagram for a single time period T and the value of T can be constant or change over time.

During a time period T, the controller unit 503 controls the third controllable semiconductor switch 5011 and the fifth controllable semiconductor switch 5013 so that they are closed for a period of time t1 and then opened for a period of time t2, and the controller unit 503 controls the fourth controllable semiconductor switch 5012 and the sixth controllable semiconductor switch 5014 so that they are opened for a period of time t1, then closed for a period of time t3, then opened for a period of time t4, and then closed for a period of time t5, wherein t1+t2=T and t1+t3+t4+t5=T. In an embodiment, t1 is much smaller than t2. In other words, the controller unit 503 generates driving signals V₅₀₁₁ and V₅₀₁₃ for driving the third and fifth controllable semiconductor switches 5011 and 5013 and applies these signals to the third and fifth controllable semiconductor switches 5011 and 5013, respectively. The controller unit 503 also generates driving signals V₅₀₁₂ and V₅₀₁₄ for driving the fourth and sixth controllable semiconductor switches 5012 and 5014 and applies these signals to the fourth and sixth controllable semiconductor switches 5012 and 5014, respectively.

In FIG. 6, the driving signals of the third controllable semiconductor switch 5011 and the fifth controllable semiconductor switch 5013 are the same as the driving signal of the first controllable semiconductor switch 1011 shown in FIG. 2(a). The driving signals of the fourth controllable semiconductor switch 5012 and the sixth controllable semiconductor switch 5014 are the as the driving signal of the second controllable semiconductor switch 1012 shown in FIG. 2(a). Thus, when the third preset control mode in FIG. 6 is adopted, the schematic diagrams of waveforms of the voltage at the terminals of the DBD lamp and the current through the lamp corresponding to the DBD lamp operating in the ignition mode and the normal operating mode, are shown in FIGS. 2(b) and 2(c), respectively.

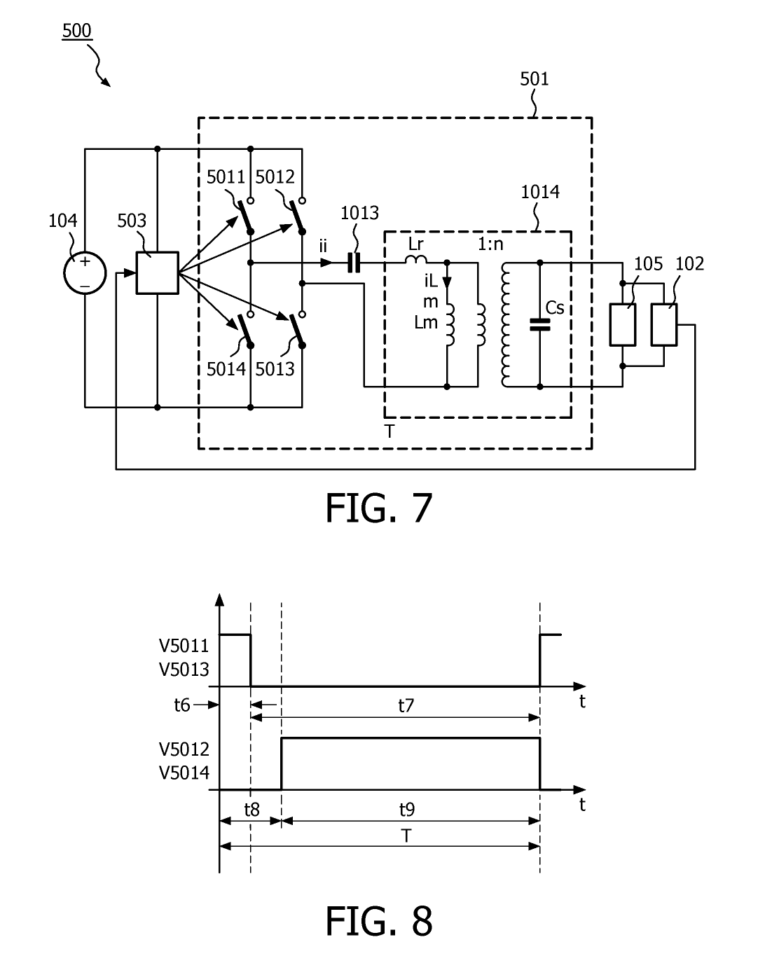

Optionally, in an embodiment, the circuit 500 in FIG. 5 can further comprise a detector unit 102 as shown in FIG. 3, which is shown in FIG. 7.

First, the detector unit 102 detects whether the DBD lamp operates in the ignition mode or in the normal operating mode.

If the DBD lamp operates in the normal operating mode, then the controller unit 503 controls the opening and closing of the third controllable semiconductor switch 5011, the fourth controllable semiconductor switch 5012, the fifth controllable semiconductor switch 5013, and the sixth controllable semiconductor switch 5014 using the third preset control mode in FIG. 6.

If the DBD lamp operates in the ignition mode, then the controller unit 503 controls the periodical or nonperiodical opening and closing of the third controllable semiconductor switch 5011, the fourth controllable semiconductor switch 5012, the fifth controllable semiconductor switch 5013, and the sixth controllable semiconductor switch 5014 using the fourth preset control mode in FIG. 8.

In FIG. 8, during a time period T, the third controllable semiconductor switch 5011 and the fifth controllable semiconductor switch 5013 are closed for a period of time t6 and then opened for a period of time t7, and the fourth controllable semiconductor switch 5012 and the sixth controllable semiconductor switch 5014 are opened for a period of time t8 and then closed for a period of time t9, wherein t6+t7=T, t8+t9=T and t6<t8.

In FIG. 8, the driving signals of the third controllable semiconductor switch 5011 and the fifth controllable semiconductor switch 5013 are the same as the driving signal of the first controllable semiconductor switch 1011 shown in FIG. 4. The driving signals of the fourth controllable semiconductor switch 5012 and the sixth controllable semiconductor switch 5014 are the same as the driving signal of the second controllable semiconductor switch 1012 shown in FIG. 4. Thus, when said fourth preset control mode in FIG. 8 is adopted and the DBD lamp operates in the ignition mode, the schematic diagram of waveforms of the voltage at the terminals of the DBD lamp and the current through the lamp is shown in FIG. 4.

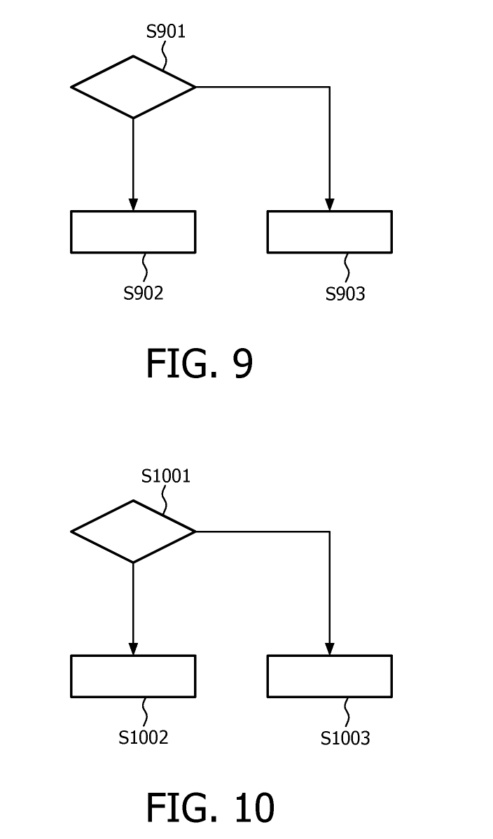

FIG. 9 illustrates a flow chart of a method of controlling the circuit 101 in FIG. 1 for converting DC into AC pulsed voltage according to an embodiment of the present invention.

In step S901, the operating mode of the load 105 is being detected. In an embodiment, step S901 can be performed by the detector unit 102 shown in FIG. 3.

If the load 105 operates in the normal operating mode, then step S902 controls the first controllable semiconductor switch 1011 and the second controllable semiconductor switch 1012 using the first preset control mode shown in FIG. 2(a) so that the first controllable semiconductor switch 1011 and the second controllable semiconductor switch 1012 are opened and closed periodically or non-periodically. In an embodiment, step S902 can be performed by the controller unit 103 in FIG. 1 or FIG. 3.

If the load 105 operates in the ignition mode, then step S903 controls the first controllable semiconductor switch 1011 and the second controllable semiconductor switch 1012 using the second control mode shown in FIG. 4 so that the first controllable semiconductor switch 1011 and the second controllable semiconductor switch 1012 are opened and closed periodically or nonperiodically. In an embodiment, step S903 can be performed by the controller unit 103 in FIG. 1 or FIG. 3.

It should be noted that, in FIG. 9, steps S901 and S903 are optional steps. In an embodiment, only step S902 is comprised. In other words, there is no need to determine the operating mode of the load 105. Whether the load 105 operates in the ignition mode or in the normal operating mode, the opening and closing of the first controllable semiconductor switch 1011 and the second controllable semiconductor switch 1012 is always controlled using the first preset control mode shown in FIG. 2(a).

FIG. 10 illustrates a flow chart of a method configured to control the circuit 501 in FIG. 5 for converting DC into AC pulsed voltage according to an embodiment of the present invention.

In step S1001, the operating mode of the load 105 is detected. In an embodiment, step S1001 can be performed by the detector unit 102 shown in FIG. 7.

If the load 105 operates in the normal operating mode, then step S1002 controls the third controllable semiconductor switch 5011, the fourth controllable semiconductor switch 5012, the fifth controllable semiconductor switch 5013, and the sixth controllable semiconductor switch 5014 using the third preset control mode shown in FIG. 6 so that those four switches are opened and closed periodically or nonperiodically. In an embodiment, step S1002 can be performed by the controller unit 503 in FIG. 5 or FIG. 7.

If the load 105 operates in the ignition mode, then in step S1003 controlling the third controllable semiconductor switch 5011, the fourth controllable semiconductor switch 5012, the fifth controllable semiconductor switch 5013, and the sixth controllable semiconductor switch 5014 using the fourth control mode shown in FIG. 8 so that those four switches are opened and closed periodically or nonperiodically. In an embodiment, step S1003 can be performed by the controller unit 503 in FIG. 5 or FIG. 7.

It should be noted that, in FIG. 10, steps S1001 and S1003 are optional steps. In an embodiment, only step S1002 is comprised. In other words, there is no need to determine the operating mode of the load 105. Whether the load 105 operates in the ignition mode or in the normal operating mode, the opening and closing of the third controllable semiconductor switch 5011, the fourth controllable semiconductor switch 5012, the fifth controllable semiconductor switch 5013 and the sixth controllable semiconductor switch 5014 is always controlled using the third preset control mode shown in FIG. 6.

It should be noted that the values of t1 to t9 can be modified according to the requirements of a practical circuit and the values of t1 and t2 can be the same or different for respective embodiments. The function of the detector unit 102, the controller unit 103 and the controller unit 503 can be implemented by mere hardware or a combination of software and hardware. For example, the function of detector unit 102, controller unit 103 and controller unit 503 can be implemented by an MCU executing corresponding programs.

Above, embodiments of the present invention have been described. It should be noted that the present invention is not limited to the foregoing specific embodiments. Those skilled in the art can make various variations or modifications within the scope of the appended claims.

1. A circuit for converting DC into AC pulsed voltage, comprising:
a converter circuit configured to drive a load, said converter circuit comprising a first controllable semiconductor switch, a second controllable semiconductor switch, a capacitor and a transformer, wherein the series circuit of said first controllable semiconductor switch and said capacitor is connected in series with the primary side of said transformer, and said second controllable semiconductor switch is connected in parallel with the series circuit of said capacitor and the primary side of said transformer, and
a controller unit configured to control the closing and opening of said first controllable semiconductor switch and said second controllable semiconductor switch, using a first preset control mode so that the switches are opened and closed periodically or nonperiodically in the following mode:
during a time period T, said first controllable semiconductor switch is closed for a period of time t1 and then opened for a period of time t2, and said second controllable semiconductor switch is opened for a period of time t1, then closed for a period of time t3, then opened for a period of time t4, and then closed for a period of time t5, wherein t1+t2=T and t1+t3+t4+t5=T.

2. A circuit according to claim 1, wherein said load operates in an ignition mode or in a normal operating mode, said circuit further comprising:
a detector unit configured to detect the operating mode of said load, wherein said controller unit is further configured to control the closing and opening of said first controllable semiconductor switch and said second controllable semiconductor switch, using said first preset control mode if said load operates in the normal operating mode.

3. A circuit according to claim 2, wherein said controller unit is further configured to control said first controllable semiconductor switch and said second controllable semiconductor switch, using a second preset control mode so that the switches are opened and closed periodically or nonperiodically in the following mode if said load operates in the ignition mode:
during a time period T, said first controllable semiconductor switch is closed for a period of time t6 and then opened for a period of time t7, and said second controllable semiconductor switch is opened for a period of time t8 and then closed for a period of time t9, wherein t6+t7=T, t8+t9=T and t6<t8.

4. A circuit for converting DC into AC pulsed voltage, comprising:
a converter circuit configured to drive a load, said converter circuit comprising a third controllable semiconductor switch, a fourth controllable semiconductor switch, a fifth controllable semiconductor switch, a sixth controllable semiconductor switch, a capacitor and a transformer, wherein the series circuit of said third and sixth controllable semiconductor switches is connected in parallel with the series circuit of said fourth and fifth controllable semiconductor switches, one terminal of the series circuit of said capacitor and the primary side of said transformer is connected to the midpoint of the third and sixth controllable semiconductor switches and the other terminal is connected to the midpoint of the fourth and fifth controllable semiconductor switches, and
a controller unit configured to control the opening and closing of said third, fourth, fifth, and sixth controllable semiconductor switches, using a third preset control mode so that the switches are opened and closed periodically or nonperiodically in the following mode: during a time period T, said third and fifth controllable semiconductor switches are closed for a period of time t1 and then opened for a period of time t2, and said fourth and sixth controllable semiconductor switches are opened for a period of time t1, then closed for a period of time t3, then opened for a period of time t4, and then closed for a period of time t5, wherein t1+t2=T and t1+t3+t4+t5=T.

5. A circuit according to claim 4, wherein said load operates in an ignition mode or in a normal operating mode, said circuit further comprising:
a detector unit configured to detect the operating mode of said load, and said controller unit further configured to control the opening and closing of said third, fourth, fifth, and sixth controllable semiconductor switches using said third preset control mode if said load operates in the normal operating mode.

6. A circuit according to claim 5, wherein said controller unit is further configured to control the opening and closing of said third, fourth, fifth, and sixth controllable semiconductor switches using a fourth preset control mode so that the switches are opened and closed periodically or nonperiodically in the following mode if said load operates in the ignition mode: during a time period T, said third and fifth controllable semiconductor switches are closed for a period of time t6 and then opened for a period of time t7, and the fourth and sixth controllable semiconductor switches are opened for a period of time t8 and then closed for a period of time t9, wherein t6+t7=T, t8+t9=T and t6<t8.

7. An driving circuit for driving dielectric barrier discharge lamps, comprising the circuit according to claim 1.

8. A method of controlling a circuit for converting DC into AC pulsed voltage, wherein said converter circuit is configured to drive a load, said converter circuit comprising a first controllable semiconductor switch, a second controllable semiconductor switch, a capacitor, and a transformer, wherein the series circuit of said first controllable semiconductor switch and said capacitor is connected in series with the primary side of said transformer, and said second controllable semiconductor switch is connected in parallel with the series circuit of said capacitor and the primary side of said transformer, the method comprising the following step:
b. controlling the opening and closing of said first controllable semiconductor switch and said second controllable semiconductor switch using a first preset control mode so that the switches are opened and closed periodically or nonperiodically in the following mode: during a time period T, said first controllable semiconductor switch is closed for a period of time t1 and then opened for a period of time t2, and said second controllable semiconductor switch is opened for a period of time t1, then closed for a period of time t3, then opened for a period of time t4, and then closed for a period of time t5, wherein t1+t2=T and t1+t3+t4+t5=T.

9. A method according to claim 8, wherein said load operates in an ignition mode or in a normal operating mode, the method further comprising steps of:
a. detecting the operating mode of said load, and
performing said step b if said load operates in the normal operating mode.

10. A method according to claim 9, further comprising the following step after said step a if said load operates in the ignition mode:
controlling the opening and closing of said first and second controllable semiconductor switches using a second preset control mode so that the switches are opened and closed periodically or nonperiodically in the following mode:
during a time period T, said first controllable semiconductor switch is closed for a period of time t6 and then opened for a period of time t7, and said second controllable semiconductor switch is opened for a period of time t8 and then closed for a period of time t9, wherein t6+t7=T, t8+t9=T and t6<t8.

11. A method of controlling a circuit for converting DC into AC pulsed voltage, wherein said converter circuit is configured to drive a load, said converter circuit comprising a third controllable semiconductor switch, a fourth controllable semiconductor switch, a fifth controllable semiconductor switch, a sixth controllable semiconductor switch, a capacitor and a transformer, wherein the series circuit of said third and sixth controllable semiconductor switches is connected in parallel with the series circuit of said fourth and fifth controllable semiconductor switches, one terminal of the series circuit of said capacitor and the primary side of said transformer is connected to the midpoint of the third and sixth controllable semiconductor switches and the other terminal is connected to the midpoint of the fourth and fifth controllable semiconductor switches, the method comprising the following step:
ii. controlling the opening and closing of said third, fourth, fifth, and sixth controllable semiconductor switches using a third preset control mode so that the switches are opened and closed periodically or nonperiodically in the following mode:
during a time period T, said third and fifth controllable semiconductor switches are closed for a period of time t1 and then opened for a period of time t2, and said fourth and sixth controllable semiconductor switches are opened for a period of time t1, then closed for a period of time t3, then opened for a period of time t4, and then closed for a period of time t5, wherein t1+t2=T and t1+t3+t4+t5=T.

12. A method according to claim 11, wherein said load operates in an ignition mode or a normal operating mode, the method further comprising steps of:
i. detecting the operating mode of said load, and
performing said step ii if said load operates in the normal operating mode.

13. A method according to claim 12, further comprising the following step before said step i if said load operates in the ignition mode:
controlling the opening and closing of said third, fourth, fifth, and sixth controllable semiconductor switches using a fourth preset control mode so that the switches are opened and closed periodically or nonperiodically in the following mode:
during a time period T, said third and fifth controllable semiconductor switches are closed for a period of time t6 and then opened for period of time t7, and said fourth and sixth controllable semiconductor switches are opened for a period of time t8 and then closed for a period of time t9, wherein t6+t7=T, t8+t9=T and t6<t8.
